(19) United States
(12) Patent Application Publication
(10) Pub. No.: US 2003/0159032 A1
(43) Pub. Date: Aug. 21, 2003

(54) Automatically generating unique, one-way compact and mnemonic voter credentials that support privacy and security services

(76) Inventor: Edgardo Gerck, San Rafao, CA (US)

Correspondence Address: Michael Hetherington, Woodside Intellectual Property Law Group, Suite 139, 108 Portola Road, Portola Valley, CA, 94028, US

(21) Appl. No.: 09/930,805

(22) Filed: Aug. 15, 2001

Related U.S. Application Data
(60) Provisional application No. 60/226,158, filed on Aug. 16, 2000.

(51) Int. Cl. H04L 9/30; G06F 17/60

(52) U.S. Cl. 713/156; 713/180; 705/12

(57) ABSTRACT

While the invention has been described with respect to what are presently considered to be the most practical and preferred embodiments, it is to be understood by one skilled in the art that the invention is not limited to the disclosed embodiment, but on the contrary, is intended to cover various equivalent arrangements and modifications which are included within the spirit and scope of the disclosure. As an example of equivalent arrangements, one skilled in the art will recognize that the system described herein can be implemented using symmetric or asymmetric encryption, and readily in total or for each part in diverse software languages, in diverse hardware, ASICS, FPGAs and embedded with each of its various parts in any portable, hand held computing system, such as a smart-card, PDA, laptop computer, or other portable, hand held device incorporating a computer, such as a cellular telephone, fax, pager or the like, devices which may be capable of being communicatively coupled with the Internet. Part of the embodiment may include the Internet or networks such as dial-up or other types of networks for any or all of its various functions.

One skilled in the art also will recognize as an equivalent arrangement the application of the methods disclosed herein to any voting system, voting organization, or voting game wherein participants need to be anonymous and/or must exchange secrets and/or make collective decisions.

Therefore, it is to be understood that all such equivalent arrangements and modifications of the system and methods disclosed herein are included within the scope of the following claims.

### RELATED APPLICATION

This U.S. patent application is based on U.S. provisional patent application serial No. 60/226,158 entitled, AUTOMATICALLY GENERATING UNIQUE, ONE-WAY COMPACT AND MNEMONIC VOTER CREDENTIALS THAT SUPPORT PRIVACY AND SECURITY SERVICES, filed Aug. 16, 2000.

### BACKGROUND

Field of the Invention

The field of the present invention pertains generally to voting and, more particularly, to a method and system for automatically generating unique, one-way, compact and mnemonic voter credentials that allay privacy and security concerns.

A Free and fair elections are not generally considered possible without a means of verifying legitimate voters. Voter registration services (hereafter, Registration Service or RS) are therefore essential in any voting system. To correctly register voters, a Registration Service usually needs to verify the voter's identity, including legal name, citizenship, address, party affiliation, signature, etc. Harry Neufeld, “The Range of Advanced Technologies Available for Election Organizations,” Let's Talk About Elections, ed. Carl W. Dundas (London: Commonwealth Secretariat, May 1997), 58. See also the Administration and Cost of Elections (ACE) Project CD-ROM, version 0.1, April 1999, a joint endeavor of the International Institute for Democracy and Electoral Assistance (IDEA), the United Nations and the International Foundation for Election Systems (IFES), also in http://www.aceproject.org/main/english/vr/vr10/default.htm

“Identity” or “true identity” of a person is understood here as a collection of facts that together and in relationship to an observer, are expected to be true for the person and no other. The first part of this definition introduces a “collection of facts” that may include birth name, married name, aliases, addresses for a period of time into the past, driver's license, fingerprint image, iris image, photograph, criminal record, DNA data, employment data, personal references, independent reports, and any other facts or number of facts that together make up a collection.

But it is not enough to correctly register voters prior to elections. During elections and in order to allow a registered voter to vote, as well as in order to control the right to vote according to the voter's registered attributes (party, place of residence, etc.), the prior art uses “voter lists” (given to verifiers by a Registration Service and confronted with information gathered from the voter at the poll site) and/or “voter credentials” (given to voters by a Registration Service and presented by the voters to verifiers at the poll site for verification).

In a conventional voting system, one example of “voter lists” is the “list of voters” that poll workers use to identify [2] and authenticate [3] voters, where the “list of voters” may also contain a copy of the voter's signature (Texas state) and/or the voter's biometric data such as eye and hair color (New York state). “To identify is to look for connections.” As defined by E. Gerck in http://www.mcg.org.br/coherence.txt in 1997 and published in the newsletter THE BELL, ISSN 1530_{—}048X, June 2000 issue, p. 13, “identification is a measure of coherence,” where coherence is a natural or logical connection.

“Authentication is the affirmation of a truth”. As defined by E. Gerck in http://www.mcg.org.br/certover.pdf in 1997 and elsewhere, authentication defines proof of a truth in terms of a qualified presumption of validity. The distinction between identification (as a connection) and authentication is that authentication involves qualified reliance on the connection, besides the mere verification of its existence. One can have identification with authentication, for example, when the presumption of validity is unknown. It is also possible to have authentication without identification, as in Zero Knowledge Proofs. A. Menezes et al., Handbook of Applied Cryptography, CRC Press, New York, 1997.

In a conventional voting system, one example of “voter credentials” is the “personal identification number” (PIN) which usually designates a set of characters and/or numbers that is given to the voter by a Registration Service, another example is the “password” which usually designates a set of characters and/or numbers that is given to the Registration Service by the voter. Usually, a voter credential needs to be unique in order to allow unequivocal control of voting rights for each registered voter. Thus, Registration Services oftentimes need to assign a second credential to voters in the case of PINs and almost always in the case of passwords (since a password is chosen by the voter and may easily be repeated among voters).

However, and as set forth infra, while voter identification to a Registration Service usually needs to reveal the voter's true identity [1], voter identification [2] to a verifier is simply a connection between a voter and the right to vote (which right to vote is usually previously defined by the Registration Service within a legal or policy framework).

A conventional voting system fails to properly distinguish between these two different acts and uses identification credentials to authenticate (for example, Social Security number) and/or authenticating credentials to identify (for example, PINs). The confusion reaches a state where identification and authentication have become synonymous in regard to information security, including applications to voting. The extent of the conventional misconception of confusing identification with authentication may be seen from A. Menezes et al., Handbook of Applied Cryptography, CRC Press, New York, 1997, as declared at page 386, item 10.2, “The terms identification and entity authentication are used synonymously throughout this book.”

In a conventional voting system, the process of registering voters and producing voters lists and/or voter credentials often accounts for more than fifty percent of the overall cost for administering elections. Harry Neufeld, “The Range of Advanced Technologies Available for Election Organizations,” Let's Talk about Elections, ed. Carl W. Dundas (London: Commonwealth Secretariat, May 1997). Thus, an improvement towards automation of the process may have a considerable effect in the industry, provided that the requirements for privacy and security are met.

Similar considerations can be made regarding conventional methods of electronic voting, where a communication network or the Internet is used for some or all of the communication exchange. When the Internet is used, a conventional electronic voting system also may use the denomination “online voting,” “digital voting” or (most commonly) “Internet voting.” These terms will be used interchangeably in this document, following current custom.

Conventional methods for electronic voting in the private sector are reviewed in Hurd (ed.), “The Private Sector Won't Wait”, in The Bell, July 2000, p. 5, ISSN 1530-048X and in E. Gerck (ed.), “The Private Sector Won't Wait, Part II”, in The Bell, August 2000, p. 5, ISSN 1530-048X. In those articles, the same disadvantageous aspects cited above are present, including the confusion of the terms identification and authentication.

Electronic voting using the Internet is legal in more than 28 U.S. States and allowed by the U.S. Securities and Exchange Commission (SEC), in the private sector. Citing from E. Gerck (ed.), “The Private Sector Won't Wait, Part II”, in The Bell, August 2000, p. 5, ISSN 1530-048X “. . . ten years ago Delaware issued legislation to clarify the conditions under which electronic voting could be utilized. The statute requires that “it can be determined that the telegram, cablegram or other electronic transmission was authorized by the stockholder” (Del. Stat. Ann. Tit. 8, S 212(c)).”

Since then, other states have passed similar statutes that permit electronic voting. California (Calif. Corp. Code Sec. 178) was the second state after Delaware to permit Internet voting in the private sector. The majority of states follow the Delaware and California provisions. For example, New York (see New York State Business Corporation Law) and most states that permit electronic voting also specifically require that some form of verification exists to authenticate the proxy sender, as in Del. Stat. Ann. Tit. 8, S 212(c). Minnesota's statute (Minn. Stat. Ann. 302A.449 (1)) is, however, silent on this requirement. “The above requirements stem from the 1989 temporary set back to electronic voting in Delaware due to a decision handed down in the case of Parshalle v. Roy. The court ruled that datagrams (e.g. A toll free number to telephonically vote a proxy) did not have sufficient indicia of authenticity. Essentially, the person making the call could not be reasonably verified to be the shareholder. Accordingly, the datagrams lacked the one “fundamental” attribute required in all proxies, i.e., “to be accepted as valid evidence of an agency relationship, the proxy must evidence that relationship in some authentic, genuine way.”

The 1990 amendments to Section 212 represented an effort to keep the law current with evolving technology. Accordingly, a stockholder should be able to cast a vote (called to “grant a proxy,” where “proxy” is a document that contains the vote) using the Internet, provided it can be determined that the transmission pursuant to which the vote (the “proxy”) was granted was authorized by the stockholder.

In a conventional system for Internet voting in the private sector, granting and verifying said authorization may include a Social Security number, birth date, or other fact known only to the stockholder such as a private-key in asymmetric cryptographic protocol. The use of a personal identification number (PIN) and/or control number, usually given to the voter as a unique identifier is a current practice in Internet voting. This occurs mostly because birth dates are neither unique nor secret while Social Security numbers involve privacy concerns.

The use of Internet voting in the public sector is yet in its infancy. It is not yet legally allowed in any U.S. state or territory, even though experiments have been performed and are also under way. “A Step toward Internet Voting”, in The Bell, August 2000, p. 1, ISSN 1530-048X. The Federal Election Commission (FEC) has no rule in place for Internet voting.

In a conventional method for Internet voting in the public sector, granting and verifying an authorization to vote may also include a Social Security number, birth date, or other fact known only to the voter such as a private-key in asymmetric cryptographic protocol [7, 8, 9]. The use of a personal identification number (PIN) and/or control number, usually given by to the voter as a unique identifier is a current practice in the public sector trials for internet voting [7, 8, 9]. This occurs mostly because birth dates are neither unique nor secret while Social Security numbers involve privacy concerns.

In a conventional voting system, regardless thus of the type of communication channel used to cast the vote (paper-based, electronic network, Internet) and regardless of the application sector (public, private), voter Registration Services need to provide a registered voter with a secure credential that can serve both as an element of proof to the effect that the voter is allowed to vote at an election and, oftentimes, as an element of proof of how that voter may or may not vote in terms of ballot styles, races, time to vote, etc. The credential must also strike the right balance between the need for the voter to use a credential that is user-friendly and the need for the system to rely on a credential that is unique and secure—for example, long and complex enough so as ensure that it provides integrity against dictionary attacks, or any form of attack or trial and error searches in case of loss or theft.

Furthermore, Registration Services need to ensure that such a credential is not self sufficient to enable voting without the voter's participation, which means that voting credentials should be unlike money or other instruments that are useful per se. And yet, in a large number of cases voting credentials must be anonymous like money, in the sense that their possession and use should not reveal the true identity of the voter, otherwise the voter may be subject to duress or open to collusion—which would compromise election integrity.

Further, as seen with respect to conventional voting systems described above, the privacy and security needs of voter registration go beyond the need for mere Registration Service privacy and security because the Registration Service needs to provide to the voter a credential which must lie outside the protected perimeter of the Registration Service and which must be presented to a selected third party (e.g., a verifier that will allow the voter to cast a vote) that also lies outside said protected perimeter. For example, the Registration Service may not be able to entirely rely on the voter not to lose the credential nor on the third party not to try to learn or disclose to others who the voter is.

Therefore, a conventional voting system seeks to provide means that are necessary but not sufficient for the identification and/or authentication of the voter as a valid voter by a selected third party (the verifier). At the same time, a conventional voting system requires an absence of means that would be necessary (even if insufficient) to break the privacy of the voter for example, by revealing the true identify of the voter.

Privacy protection is indeed an important concern in voter registration because the voter needs to disclose private data to the Registration Service. This is of heightened importance in countries like the U.S. that allow any third party to collect, send or intermediate voter registration data to the Registration Service. It is not uncommon for these third parties to share the voter's name, address and all other otherwise private data with their commercial sponsors, hosting or media services, affiliates and business partners. Of course, one of the main motivating factors for partners to join such voter registration campaigns is that they will obtain a list of names and addresses. Under the legal doctrine of “relying party,” a company involved in collecting voter registration data may not even need to care what privacy policy a business partner has or follows if the business partner assumes full responsibility for the data received, which responsibility no one actually verifies. Thus, if a company collects voter registration data and the company has fifteen sponsors, ten media services (newspapers, websites, etc.), five affiliates and twenty business partners involved in the data collecting campaign, all forty companies may receive a copy of the private voter registration files. This may happen even if the data is collected with assurances that it will not be shared with third parties, because none of those mentioned are “third parties” in that process of voter data collection.

Such privacy loopholes become worse in countries like the U.S. that have no statutory protection on privacy. Even though the California constitution, for example, affords privacy the constitutional status of an inalienable right on a par with defending life and possessing property, the U.S. constitution does not address the right to privacy. In the U.S., a “Right for Privacy” would demand a change to the constitution. This is unlikely to proceed with the speed that seems required by current actions that erode such privacy as mentioned above, and as well known from current business practice. Furthermore, “Free Speech” is a right defended by the U.S. constitution and that mitigates against a ruling in favor of privacy rights that may appear to clash with a company's right to freedom of expression.

Thus, not only economic factors call for improvements in the prior art of voter registration (often, the single most important cost factor in an election. Harry Neufeld, “The Range of Advanced Technologies Available for Election Organizations,” Let's Talk about Elections, ed. Carl W. Dundas (London: Commonwealth Secretariat, May 1997), but also security concerns and privacy exploitation with current systems and under the current and foreseeable U.S. legal regime show that there is a need to improve various aspects of voter registration methods as previously mentioned.

Even in the case of voting methods such as online voting, improvements in voter registration must allow both online as well as offline identification. E. Gerck in http://www.mcg.org.br/coherence.txt, and published in the newsletter THE BELL, ISSN 1530_{—}048X, June 2000 issue, and/or authentication E. Gerck in http://www.mcg.org.br/certover.pdf (1997). Improvements in voter registration are needed not only because communication lines to the Registration Service may fail during an election, but also to avoid opportunities for collusion and setting off race conditions between the registrar service (that can access the voter's private data) and a verifier when allowing voters to vote (for example, a voluntary or involuntary delay in voter confirmation as a function of party affiliation).

Therefore, what is needed is a method for one-way voter identification and/or authentication that may be accomplished by a third party by means of a credential given to a voter by a Registration Service, but only insofar as the third party was selected by the voter Registration Service and without the third party knowing any of the voter's private data. After the identification and/or authentication of a voter, the third party must not gain or be allowed to gain any information that might be necessary to reveal the true identity of the voter or any other data that may influence the election, its result or cause harassment or benefit to the voter, present or future. Furthermore, loss or theft of a voter credential must not enable anyone else to impersonate the voter or reveal the voter's true identity.

What is also needed is a way to provide voters with secure and unique credentials for a large and a priori unknown number of voters, wherein the credentials are always short enough to be memorized or kept at hand, are user friendly and avoid ambiguous symbols, are not self sufficient, neither for identification nor for authentication by someone that may find or obtain one or any number of credentials, and It also would be desirable if the secure and unique credentials would include identification and/or authentication data not only for the voter, but also for any aspect of voting, including but not limited to the Registration Service used, ballot, ballot style, party, time to vote and tallying methods.

Furthermore, there is a need for a voting method which must be able to provide a high degree of automation without compromising security or privacy, as working in an automated environment for data entry, selection and output, in order to reduce human error, frauds, costs and time consumption. The method must be able to work either online or offline.

### SUMMARY OF THE INVENTION

In order to overcome the aforementioned shortcomings of conventional Internet voting systems, a first aspect of the invention provides a voter credential which is a set with limited number (for example, up to five or six) of unambiguous characters from an alphabet of signs, and such that the distinguished combinations for all the voter credentials span a very large number (for example, one trillion) of possibilities. The very large number represents the maximum number of unambiguous voter credentials that can be assigned, for a given choice of alphabet of signs, unambiguous characters and maximum number of characters per credential. The voter credential may have fixed or variable length. For example, without limitation, if the alphabet of signs is the ASCII set of 256 characters and the set of unambiguous characters is the set of 32 characters with the numerals 0 to 9, the upper-case letters A to Z and excluding the confusing character “O” (confuses with the numeral “0” in the set), the confusing character “I” (confuses with the numeral “1” in the set), the confusing character “M” (confuses with the letter “N” in the set) and so on until a set of 32 unambiguous characters is chosen, the voter credential may be a set of any six of said unambiguous characters and will span a total of 32⁶ possibilities, which equals 1,073,741,824. The method could also have overloaded “0” with “O”, so that a user could enter either one of them but with the same result. Exclusion or overloading of characters may be used together with grouping of characters, neighboring or not, in order to reduce an alphabet of signs to a set of unambiguous choices to a user or to a collective of users, where multiple user profiles may be contemplated and even identified by the characters entered by the user or otherwise. Further, if a voter enters an invalid character (e.g., the character “O” if that was excluded), the disclosed system may overload that character with a valid character (in this case, the acceptable digit “0”) and count it or may also discard it, which policy the Registration Service may define at will.

In the preferred embodiment, the number of possible voter credentials in the set is a power of two, while the number of characters is fixed at six. The main reasons for these choices are: (i) to allow fast binary arithmetic in computers; (ii) to make it is easy for users to read, write down and/or eventually memorize their voter credentials; (iii) to aid users in visually counting and verifying the six characters in a row; and (iv) to afford a large enough number of possibilities so as to discourage or render impractical an attack that might try to guess a vote credential; and (v) to provide a large range of values compared to the number of voters that may be registered to vote at a national Registration Service in a large-population country (China) or worldwide. However, the use of four to eight characters might be beneficial in some cases. The preferred alphabet of signs is the ASCII set, well-known and used in the art.

An aspect of the invention thus provides a user-friendly, mnemonic and compact data representation for the voter credential, for example Z3M-7BC (where the hyphen is provided as an optional visual counting aid). The number of unique combinations that can be described in the preferred embodiment is 1,073,741,824 with the six character [0 . . . Z] voter credential, hereafter designated by the symbol C* for this encoding.

The number 1,073,741,824, albeit large, does not however provide a guarantee against collisions of credentials if credentials are randomly assigned to voters.

Another aspect of the invention further provides a guarantee against credential collisions, transparently to the voter, while optionally allowing for a number of secure desirable services in voting processes and in authenticating a voter, such as, without limitation: (i) identification of the Registration Service that issued the credential; (ii) identification of a ballot style as selected by the Registration Service to the voter; (iii) use of the voter's physical memory for data that is in recall memory (data that can be recalled at will by the voter, without external clues, such as date of birth); (iv) use of the voter's physical memory for data that is in recognition memory (data for which the user needs to recognize a clue in order to be recall it, such as a complex but unique graph that the voter was trained to recognize among similar graphs); (v) requiring a secret and/or biometric key for the voter to use the credential; (viii) revealing a secret which can be used as proof in authentication and auditing protocols, proving in a balance of probabilities that the voter used the credential; (vii) revealing a secret which can be used as proof in non-repudiation protocols that protect against the verifier later denying verifying the credential; (viii) revealing a secret which can be used as proof in non-repudiation protocols that protect against the voter later denying using the credential to vote; (ix) providing for secrecy and privacy in all items.

### BRIEF DESCRIPTION OF THE DRAWINGS

The foregoing and other advantages of the invention may be appreciated from the following drawings in conjunction with the detailed description in which:

FIG. 1 shows a logic diagram for a system in accordance with an aspect of the present invention.

### DETAILED DESCRIPTION OF THE PREFERRED EMBODIMENTS

The method given below is a non-limiting example of the disclosure. The method begins with the voter registration data files already collected, verified by a Registration Service (RS) and trusted to be correct.

The preferred embodiment achieves a lossless compression of the data in the credential, especially to a human voter, for example encoding the voter credential 104-305-188-648-4 as Z3M-07C (where the hyphen is provided just as a visual counting aid).

The number of combinations that can be described in the preferred embodiment is 1,065,151,889,408 in six-char [0 . . . Z] voter credentials, hereafter designated by the symbol C* and called credential”. This number, albeit large, does not provide a guarantee against collisions of credentials if credentials are randomly assigned to voters. The disclosed method provides a guarantee against collisions while optionally allowing for some desirable properties in authenticating a voter, such as an identification of the voter Registration Service (RS) that issued the credential, identification of a ballot style as selected by the Registration Service to the voter, use of memory-based data (e.g., date of birth) as a key for the voter to use the credential, and providing for secrecy and privacy, all encoded in the credential.

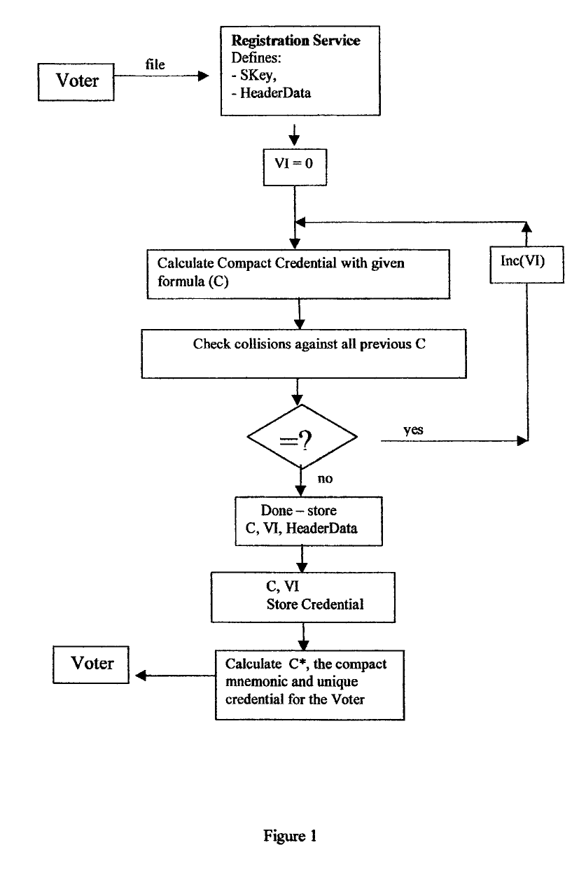

FIG. 1 shows a method for automatically generating unique voter credentials at a registrar service that are one-way, short and mnemonic by (1) receiving voter registration files containing private voter data; (2) assigning an initial collision index and a header data to a voter file; (3) hashing the voter file with the initial collision index and the header data into a canonical form; (4) folding the canonical form and producing a result with reduced length; (5) calculating a modulo division of the result so as to further reduce its length and thus produce a pre-credential; (6) encoding the pre-credential into a desired mnemonic form for a credential; (7) verifying whether that credential is unique among all previously calculated credentials for the voter registration files; (8) if the credential is not unique, assign a new collision index and reiterate the method by hashing the voter file with the new collision index, and so on until the credential is unique; (9) if the credential is unique, append to the voter file both the credential and the collision index, and iterate to the next voter file; (10) providing to the voter a voting ticket with the voter credential and/or data derived from the credential. The voting ticket may be used to identify and/or authenticate the voter and/or authenticate what the voter is authorized to vote on and/or authenticate any attribute of voting for that voter including time, to a selected third-party and/or to the registration service itself, all without privacy concerns beyond those that are acceptable by the voter and/or by the registration service.

Before beginning, VoterDataTable is updated, with changes, deletions and additions to the voter database. Any changed or added voter record is flagged with C=null. Any non_valid voter record is flagged with VoterData=null. HeaderData is an optional field defined by the RS for each voter and allowing for some desirable properties in authenticating a voter, such as an identification of the voter Registration Service (RS) that issued the credential, identification of a ballot style as selected by the Registration Service to the voter, use of memory_based data (e.g., date of birth) as a key for the voter to use the credential, and providing for secrecy and privacy, all encoded in the credential.

Referring to FIG. 1, the fields are defined as follows.

Define:

VoterData is the entire voter registration data for each voter, as defined by a RS.

C* is the unique voter credential in six char [0 . . . Z] format using a selected set of 32 characters, to be calculated and given to the voter.

C is C* in binary format.

VI is a voter index, a number and/or also a combination of numbers in fields representing various internal quantities that are unknown a priori and presents no privacy concerns to the voter.

HeaderData is an optional field that may be defined by the RS for each voter, allowing for some desirable properties in authenticating a voter, such as an identification of the voter Registration Service (RS) that issued the credential, identification of a ballot style as selected by the Registration Service to the voter, use of memory_based data (e.g., date of birth) as a key for the voter to use the credential, providing for secrecy and privacy, and other features as mentioned without limitation in the summary of the invention, all as encoded in the credential. This can take the form of a number and/or also a combination of numbers in fields representing various external and internal quantities that are known a priori and present no privacy concerns to the voter.

VoterDataTable is a database table with VoterData, C, VI and EI (some C, VI and EI are already calculated and need to be kept, some will be calculated because they are new records).

VoterCredentialTable is a database table only with records (C,VI), which present no privacy concerns. It is also a smaller table than VoterDataTable, which facilitates calculating VI.

For each voter, the method defines C* as a unique, mnemonic and [0 . . . Z] encoded voter credential, which credential supports the provision of private and secure services to the voter including the credential itself.

Before beginning, VoterDataTable is updated, with changes, deletions and additions to the voter database. Any changed or added voter record is flagged with C=null. Any non valid voter record is flagged with VoterData=null.

BEGIN METHOD
Create empty VoterCredentialTable with records (C, VI);
FOR EACH record in VoterDataTable DO

BEGIN
IF (VoterData <> null) DO STORE (C, VI) as a new record in VoterCredentialTable;
END;

FOR EACH record in VoterCredentialTable DO

BEGIN
IF (C == null) DO

// HeaderData can be fixed or may change per voter, as provided by a database query
// or case by case
READ HeaderData;

BEGIN
VI = 0;
Label ALG1;

// the argument form below is not a restrictive disclosure but a non-binding example.
// The hash function is SHA-1, 20-byte wide, as a non-binding example. It can be also be MD5 or
// any other one-way function based on random number generators or ancryption algorithms that
//map a set of data to another set of data (not necessarily with a fixed-length result as
// SHA-1 and MD5) in such a way that knowledge of the result does not immediately
//provide the input.
//For security reasons, to prevent a dictionary attack by knowing all possible results, the
//hash function may use an argument space that is larger than the result space, mapping a
//higher dimensional space onto a lower dimensional space. This can be accomplished also
//by increasing the length of the unknown parts in “VI | HeaderData | VoterDate|VI”
// to more than 20-bytes for a given hash
// function design such as SHA-1 with 20-byte output.
// The order of the hashing, folding and modular arithmetic operations is also just illustrative,
// not limitative.

HVD = hash (VI | HeaderData | VoterData | VI);
// this possibly introduces some collisions even though HVD is 20_byte wide in this example.
// Now, the RS folds HVD, which is a 20_byte number, into FHVD, a 10_byte number,
// possibly introducing some other collisions. This is an example of “folding” that can be
// done in other ways or not done at all (0-fold). Here, shl is shift_left. (HVD shl 10 byte)
// contains the original rightmost 10 bytes in its leftmost 10 bytes. This xor HVD has

// in the leftmost 10 bytes the “xor_folded” result from the 20 bytes, which is then masked
// and results only in the leftmost 10 bytes.

FHVD = (HVD shl 10 byte) xor (HVD) and FFFFFFFFFF0000000000;
// Next, a trial credential C is calculated
C = (FHVD modulo the number of desired unique combinations);
// where C is still a binary number, just modulo ZZZZZZ in the preferred encoding.
// The remainder of the modulo operation that defines C is ignored and its existence does
// NOT mean that there is a collision because that position may be free. However, possibly, we
// have new collisions plus the ones when the RS calculated FHVD, plus the ones when
// HVD was calculated.
// Now, if there is a collision then VI is incremented by one count and the C is re-calculated,
IF C == any stored C in VoterCredentialTable then BEGIN Inc(VI); GOTO ALG1; END;

STORE (C, VI) as a new record in VoterCredentialTable;

// the next step flags the voter record as processed and creates a reverse link from

// C to VoterData

STORE (C, VI, HeaderData) in VoterDataTable;
// HeaderData can be stored by reference or by value
// To save space, VI may not be stored if VI==0 (the usual case), in which case VI==0

//can be encoded as null.

END;
// the above means that if there is a collision in C when compared to any previously

//calculated (and stored) C at that RS (without any need to look into the VoterData private
// files in the database), then VI is re-seeded, HVD is re_calculated, FHVD is re_calculated
// and C as well, until there are no collisions.

// In actual code, a counter with range(VI) is used to block endless repititions (bugs,

// for example), throwing an exception if exceeded.

// A new database table is created, and the original one is reset with the new Cs.
END METHOD.

The user-friendly credential value C* can be calculated at any time by encoding C in [0 . . . Z], base-32, 6 char. Note that C can always be encoded in [0 . . . Z] as a 6-char 32-bit name without collisions between these two formats, so that there is no loss in changing from C to C* or vice-versa.

This method is always feasible even for a registrations service as the database changes in time, without changing any of the previously issued C/C* because there are much less humans in the planet than 1,073,741,824.

A statistical flat distribution is achieved in C when varying VI because VI enters in the argument of the first hash function—a change of even one bit in VI will tend change all bits in C for a well-designed hash function such as SHA-1. For a country with a federal registry of 180,000,000 voters, the probability of a collision is 0.0002 in this case of six characters, but this is provided without changing VI. Since VI can be changed until there is no collision, the probability that a collision subsists after (suppose) 256 VI values have been tried is vanishingly small and can be reduced even further as VI is increased.

The value of VI is an internal index of collisions, and the RS may keep it in the main database VoterDataTable, to avoid re-incurring the small cost of VI discovery—but such is not necessary in the preferred embodiment. VI can be seen as a cache value, stored together with C. Note that the RS may use C and VI internally, while it may use only C* externally. The uniqueness of C at that RS allows this possibility.

Thus, a method is disclosed which produces in a world population-scale a voter credential that is one-way, very compact, mnemonic, and unique with an automatic generation procedure, which supports privacy and secure services including non-repudiation and which also controls the presentation of information to the voter. For every voter, there is a unique C. For every stored C there is only one voter, as associated in a database table with C and VoterData. Further, C can contain encoded data as desired by the Registration Service, which data controls the use of the credential by the voter as well as the presentation of races and ballot options to the voter, in addition to authentication and non-repudiation services. What is clamed is:

1. A method for generating a unique, one way, compact mnemonic credential for identifying and separately authenticating a voter while maintaining voter privacy comprising:
defining a database for identification of voters, wherein said data base comprises registration data for each voter;
defining a collision index corresponding to each voter in said database, wherein the collision index is a number unknown a priori;
defining an authentication record for each voter, assigning a subset from a selected set of characters to each voter in the database;
providing a computer means for calculating said collision index which is used to select a different authentication record, such that each voter authentication record is unique within a given length;
creating thus a one way mapping of a higher dimensional argument space onto a lower dimensional space without collisions such that the mapping cannot be inverted.

2. A method for generating a unique, one-way, compact credential for identifying and separately authenticating a voter while maintaining voter privacy as in claim 1 further comprising:
applying the collision index as part of an argument of a hash function used to select a different authentication record, such that each voter authentication record is unique within a given length; wherein the hash function creates thus a one way mapping of a higher dimensional argument space onto a lower dimensional space without collisions and so that the hash function cannot be inverted.

3. A method for generating a unique, one way, compact mnemonic credential for identifying and separately authenticating a voter according to claim 1 further comprising:
translating the credential into a mnemonic string according to a language rule while preserving credential uniqueness in that language.

4. A method for generating a unique, one-way compact mnemonic credential for identifying and separately authenticating a voter while maintaining voter privacy as in claim 1 further comprising:
providing a verification key of sufficient length to enable a verifier to authenticate information encoded in the credential while enabling the credential to be made secure against attacks.

5. A method for generating a unique, one way compact c credential for identifying and separately authenticating a voter while maintaining voter privacy as in claim 4 comprising: providing a local feedback loop, responsive to the collision index for ensuring information encoded in the credential shall be reliably discovered only by a verifier that has the correct verification key

6. A method for generating a unique, one way, compact credential for identifying and separately authenticating a voter over a communication channel while maintaining voter privacy comprising:
defining a database for identification of voters, wherein said data base comprises registration data for each voter;
defining a collision index corresponding to each voter in said database, wherein the collision index is a number unknown a priori;
defining an authentication record for each voter by assigning a subset from a selected set of characters to each voter in the database;
calculating a one-way mapping without collisions from said collision index such that a different authentication record is selected wherein each voter authentication record is unique within a given length; and wherein the voter authentication record provides a credential unique to each voter;
translating the credential into a data packet matched to a specific type of communication channel for transporting said credential from a source to a destination along said communication channel;

7. A method for providing a unique, one way voter credential comprising:
providing a voter database comprising voter registration data for each voter;
providing a unique voter credential for each voter;
providing a voter index corresponding to each voter in the voter data base;
mapping the unique voter credential to the voter index for each voter to create a voter data table;
using a one way function to map without collisions in the result space, each record in the voter data table, to another set of data as a result space, such that the argument space can have collisions and can be larger than the result space and knowledge of the result does not provide knowledge of the voter data.

8. A method for automatically generating unique voter credentials at a registrar service that are one-way and short comprising:
providing a plurality of voter registration files containing private voter data;
assigning an initial collision index and a header data to each voter file;
hashing the voter file with the initial collision index and the header data into a canonical form;
folding the canonical form and producing a result with reduced length;
calculating a modulo division of the result to further reduce its length and thus produce a pre-credential;
encoding the pre-credential into a desired mnemonic form for a credential such that each credential is unique among all previously calculated credentials for the voter registration files and wherein said credential may be used to identify and/or authenticate the voter to a selected third-party and/or to the registration service without loss of voter privacy.

9. A method according to claim 8 further comprising;
verifying whether the encoded credential is unique among all previously calculated credentials for the voter registration files; and
if the credential is not unique, assigning a new collision index and reiterate the method by hashing the voter file with the new collision index, until the credential is unique;

10. A method according to claim 8 further comprising translating the credential into a mnemonic string according to a language rule while preserving credential uniqueness.
